(19) United States
(12) Patent Application Publication
(10) Pub. No.: US 2003/0208312 A1
(43) Pub. Date: Nov. 6, 2003

(54) Cruise control and/or adaptive cruise control system

(76) Inventors: Klaus Winter, Schwieberdingen (DE); Thilo Beck, Stuttgart (DE); Jens Lueder, Kornwestheim (DE)

Correspondence Address: KENYON & KENYON, ONE BROADWAY, NEW YORK, NY, 10004, US

(21) Appl. No.: 10/137,091

(22) Filed: May 1, 2002

(51) Int. Cl. B60K 31/00

(52) U.S. Cl. 701/96; 701/97; 180/170

(57) ABSTRACT

A method is for operating a cruise control and/or adaptive cruise control system for a motor vehicle, and a cruise control and/or adaptive cruise control system includes a sensor unit alignable in relation to a radiation characteristic and includes a control unit. Furthermore, information, which prevents operation of the sensor unit as long for as the sensor unit is not aligned, is introduced into the control unit before a first startup of the system.

### FIELD OF THE INVENTION

The present invention relates to a method for operating a cruise control and/or adaptive cruise control system for a motor vehicle, a cruise control and/or adaptive cruise control system for a motor vehicle, a control device for a cruise control and/or adaptive cruise control system for a motor vehicle, and a corresponding motor vehicle itself. Furthermore, the present invention relates to a computer program including program code and a computer program product including program code which is stored on a computer-readable data carrier. Control systems are also, for example, referred to as Adaptive Cruise Control Systems (ACC).

### BACKGROUND INFORMATION

An ACC system based on radar is described in SAE paper 961010 (SAE Technical Paper Series 961010, International Congress & Exposition, Detroit, Feb. 26-29, 1996, “Adaptive Cruise Control System—Aspects and Development Trends”, Winner, Witte, Uhler, Lichtenberg, Robert Bosch GmbH). In this case, the radar sensor, which may have multiple targets, is attached to the front side of a motor vehicle in order to determine distances and relative speeds to vehicles traveling ahead. The data determined by the radar system is supplied to a control unit via a bus system. This control unit determines an appropriate acceleration request with reference to the radar data communicated and the driver's intent, which is in turn communicated to a longitudinal control. The longitudinal control controls actuators in accordance with the acceleration request of the control unit. These actuators may be the engine of the motor vehicle, the clutch, or the brakes of the motor vehicle. A specific behavior of the motor vehicle results on the basis of the corresponding actuation of the actuators, which is in turn fed back to the control unit and thus forms a closed loop. An operating limit is provided in the system in that the system is automatically deactivated at speeds below 40 km/h.

A method and a device for detecting a vertical misalignment of a distance sensor is described in German Published Patent No. 196 50 863. In this case, pitching movements of the motor vehicle are recognized and correlated with data and/or signals which are generated and conditioned by the distance sensor and which contain target detections and/or target detection losses. A signal is generated as a function of the result of this correlation, with reference to which a possible misadjustment or misalignment of the distance sensor is recognizable.

German Published Patent Application No. 199 64 020 describes a method and a device for misalignment recognition in a motor vehicle radar system. In this case, electromagnetic waves are emitted and the electromagnetic waves reflected from a stationary object are received and analyzed. The analyzable signals are the relative angle and a relative distance between the stationary object detected and a reference axis of the motor vehicle, as well as a relative speed between the stationary object detected and the motor vehicle. Following this, a correction value for the relative angle is determined with reference to the relative angle and the relative distance between the motor vehicle and the detected stationary object and with reference to an intrinsic speed of the motor vehicle.

German Published Patent Application No. 100 19 182 describes a method and a device for determining a misalignment of the radiation characteristic of a sensor for the cruise control of a motor vehicle. The method is characterized by at least two different distinctive individual methods for determining the misalignment, the misalignment values of the individual methods are linked with one another into a linked misalignment value and the cruise control system is switched off if a value formed from the individual misalignment values and from quality numbers is greater in value than an assigned, selectable limiting value, or one of the misalignment values of the individual methods, which is weighted using the associated quality number, is greater than an associated, selectable limiting value.

Thus various automatic methods for determining a misalignment of a motor vehicle radar system are conventional. In practice, while a motor vehicle is being driven, if a misalignment of the motor vehicle radar system is recognized which could impair the function of the system, the system is, generally, deactivated and the malfunction is signaled to the driver.

Upon the installation of a motor vehicle radar system into a newly produced motor vehicle, a factory alignment is performed afterwards, since tolerances result through the installation of the radar system into the new motor vehicle which could result in a misalignment of the radiation characteristic of the radar system or of the cruise control and/or adaptive cruise control system. The same problem results if, for example, a radar system is removed and installed or is replaced by another/new radar system during repair.

It is an object of the present invention to provide that a motor vehicle which is equipped with a cruise control and/or adaptive cruise control system is not delivered to a customer or a buyer of the motor vehicle without the necessary factory alignment.

### SUMMARY

A method for operating a cruise control and/or adaptive cruise control system for a motor vehicle including a sensor unit alignable in relation to a radiation characteristic and including a control unit may provide the advantage that information, which prevents operation of the sensor unit as long as the sensor unit is not aligned, is introduced into the control unit before a first startup of the system. This measure according to the present invention may prevent, in a simple and cost-effective manner, a cruise control and/or adaptive cruise control system from being delivered to a customer without a factory alignment. It may be ascertained that operation of the sensor unit is not possible during a final acceptance inspection at the end of the motor vehicle production line or, at the latest, during a first short trip of the motor vehicle from the production hall to the shipping location. The same advantages may result during a first startup after a visit to a service center.

According to the present invention, the information in the control unit may be correspondingly changed and the operation of the system may be enabled when alignment of the system has occurred. This measure according to the present invention may occur automatically in the course of the factory alignment or an alignment.

An example embodiment according to the present invention provides that the information is coded in such a manner that it is possible to differentiate between various states. These various states may, for example, be a delivery state, a misaligned sensor, or an aligned sensor, for which the alignment was performed. The example embodiment provides that the various coded states characterize a degree of misalignment of the radiation characteristic of the sensor unit and that, in the event of an applicable threshold value being exceeded, deactivation of the system occurs and reactivation of the system is prevented as long as realignment of the system has not occurred. An advantage of storing a degree of misalignment as information in the control device or control unit is that at a specific degree of misalignment the proper functioning of the cruise control and/or adaptive cruise control system is still provided, however, a memory entry including the information of the degree of misalignment provides important information about the misalignment of the system during a subsequent maintenance period in a service center. The information that the sensor unit is in the delivery state or that a degree of misalignment exists which prevents activation may be introduced into the control unit during production of the control unit, during replacement of the sensor unit, or during programming at the end of the production line during the production of the new motor vehicle. These measures according to the present invention may ensure that the information reliably reaches the control unit.

A cruise control and/or adaptive cruise control system for a motor vehicle according to the present invention including a sensor unit alignable in relation to a radiation characteristic and including a control unit may provide that information, which prevents operation of the sensor unit as long as the sensor unit is not aligned, may be introduced into the control unit before a first startup of the system. An example embodiment of the system provides that a storage location for the information is provided in which data, which characterizes the various states of a degree of misalignment of the radiation characteristic of the sensor unit, may be introduced during operation of the system.

The cruise control and/or adaptive cruise control system according to the present invention is thus suitable for performing the method steps previously described.

A motor vehicle according to the present invention may be equipped with a cruise control and/or adaptive cruise control system according to the present invention.

The implementation of the method according to the present invention may be in the form of a control device or a control unit for a cruise control and/or adaptive cruise control system for a motor vehicle. In this manner, an arrangement for performing the steps of the method previously described may be provided.

Furthermore, the example embodiments may be in the form of a computer program including program code and in the form of a computer program product including program code. The computer program according to the present invention includes program code to perform all steps of the method according to the present invention when the program is executed on a computer, e.g., a control device/control unit for a cruise control and/or adaptive cruise control system for a motor vehicle. In this case, the present invention is therefore implemented by a program stored in the control device or the control unit, so that this control device, which is provided with the program, represents the present invention in the same manner as the method which the program is suitable for performing. The computer program product according to the present invention includes program code which is stored on a computer-readable data carrier in order to perform the method according to the present invention when the program product is executed on a computer, e.g., a control device for a cruise control and/or adaptive cruise control system for a motor vehicle. In this case, the present invention is therefore implemented by a data carrier, so that the method according to the present invention may be performed when the program product and/or the data carrier is integrated into a control device for a cruise control and/or adaptive cruise control system for a motor vehicle. An electric storage medium may be used as a data carrier and/or as a computer program product, for example a read-only memory (ROM), an EPROM, or even an electrical permanent memory such as a CD-ROM or DVD.

Further features, possible applications, and advantages of the present invention are described below in conjunction with example embodiments of the present invention, which are illustrated in the following figures. In this case, all described or illustrated features form the object of the present invention alone or in any desired combination, independently of their summary in the patent claims or to what they refer and independently of their formulation and/or their representation in the figures.

### BRIEF DESCRIPTION OF THE DRAWINGS

FIG. 1 illustrates a cruise control and/or adaptive cruise control system according to the present invention, the illustration in FIG. 1 clarifying the regulation concept.

FIG. 2 also illustrates a cruise control and/or adaptive cruise control system according to the present invention,

FIG. 2 clarifying the structural unit of the sensor unit and the control unit.

FIG. 3 illustrates a method according to the present invention.

### DETAILED DESCRIPTION

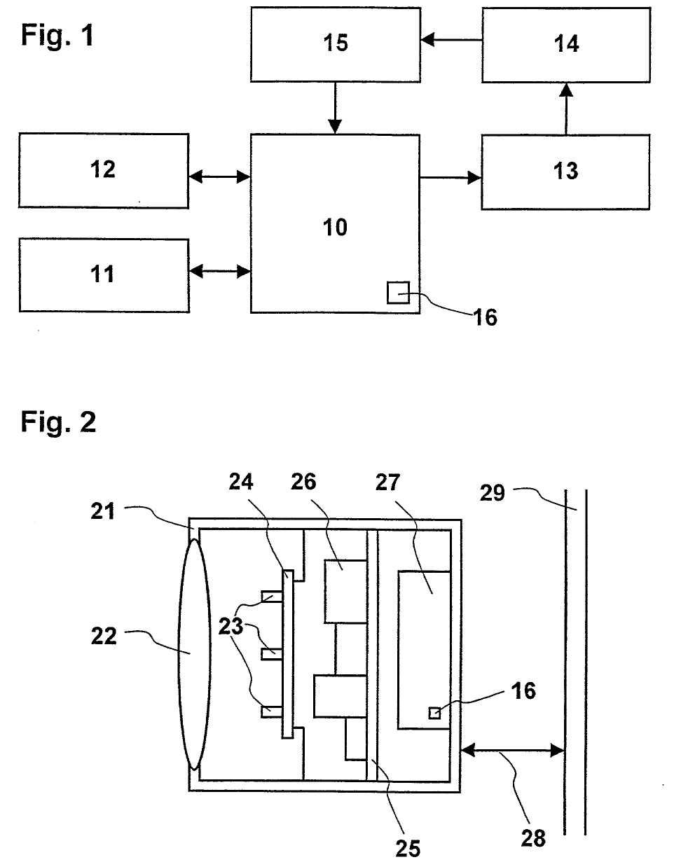

FIG. 1 illustrates a cruise control and/or adaptive cruise control system for a motor vehicle according to the present invention. In this case, a central control unit 10 (ACC controller) represents the central point of the control system. Speed and distance data about vehicles traveling ahead (and also data about other detected objects) is communicated from a radar sensor 11 to control unit 10. Radar system 11 illustrated is based on high-frequency microwave radiation, but also may alternatively be configured as a lidar or infrared sensor. The method according to the present invention is not restricted to a special type of sensor in regard to the radar technology, but rather is, in principle, usable in connection with any type of sensor. The speed data about vehicles traveling ahead communicated from radar unit 11 to control unit 10 are relative speed values in relation to the speed of its own vehicle. Furthermore, signals are communicated from driver 12 of the motor vehicle to control unit 10. These signals may be, for example, gas pedal positions, braking activities, steering movements, or even operating functions for the ACC system. From the data supplied by driver 12 and radar unit 11, the control unit determines an acceleration request which is communicated to a longitudinal control 13 (LOC). Longitudinal control 13 has the purpose of converting the acceleration request determined by control unit 10 into corresponding actuation signals for actuators 14. Actuators 14 may generally be accelerating or accelerating arrangements. A throttle control may, for example, be possible as a decelerating arrangement, while an intervention in the braking system may, for example, be regarded as a decelerating arrangement. A corresponding driving behavior of vehicle 15 results according to the actuation of the actuators. This current vehicle state data is communicated from vehicle 15 to control unit 10. Through this feedback of the current vehicle data, the closed loop which includes control unit 10, longitudinal control 13, actuators 14, and vehicle 15 is complete. The information according to the present invention which is introduced into control unit 10 is schematically illustrated using reference number 16. The information stored in the appropriate storage location of control device or control unit 10 is appropriately taken into account by control unit 10. If, for example, information is introduced to the effect that operation of the sensor unit is to be prevented, the control unit prevents activation of radar system 11 and signals the corresponding state to driver 12.

FIG. 2 illustrates the possible structural unit including the radar unit and the control unit. An example of this is illustrated in FIG. 2 with reference to a three-beam radar system. A housing 21 is terminated in the main beam direction by a lens 22, which is, for example, dielectric. Within the housing, three radiator elements 23 are positioned on a circuit board 24, which is in turn connected to housing 21. Furthermore, a second circuit board 25 is positioned inside housing 21, on which a high-frequency circuit part 26 is located, which is used to actuate radiator elements 23 and analyze the signals of radiator elements 23. A control unit 27 is also illustrated, which is integrated in housing 21 in this example embodiment. Therefore, radiator elements 23, high-frequency part 26, and control unit 27 all form a joint structural unit. Control unit 27 is in contact via a connecting line 28 with a motor vehicle bus system 29 (CAN bus) for data exchange with other control units within the control device network in the motor vehicle. The information introduced into the control unit is again schematically illustrated using reference number 16 inside control unit 27. In the illustration in FIG. 2, control unit 27 is implemented as a structural unit with the radar system. However, the method according to the present invention and the device according to the present invention are not restricted to one structural unit. It is within the scope of the method according to the present invention and the device according to the present invention that the control functions are, for example, also assumed by an engine control device.

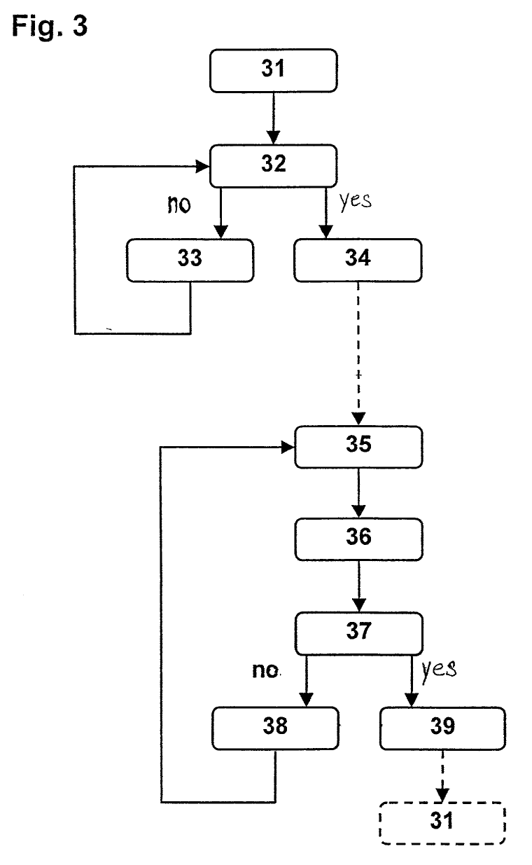

FIG. 3 illustrates an example embodiment of the method according to the present invention for operating a cruise control and/or adaptive cruise control system for a motor vehicle. In this case, the upper part of the method including method steps 31 to 34 describes method steps which execute during the production of the motor vehicle in the factory, while the lower part of the method according to the present invention including method steps 35 to 39 represents the later driving operation of the motor vehicle using the ACC system according to the present invention. However, the structural unit may provide that information 16 may be introduced early into control unit 27, which is more technically complicated if the control unit is the engine control device of the motor vehicle.

The method begins in a step 31 with introducing information into the control unit. The information may be coded in this case in such a manner that it is possible to differentiate between various states. In the simplest case, these are at least the two states:

1. Delivery state or sensor misaligned

2. Alignment performed.

In a step 32 of the method it is checked whether alignment has occurred and/or whether the sensor unit is still in the delivery state. If it is determined that the sensor unit is still in the delivery state and/or alignment has not occurred, the method continues using step 33. In step 33, operation of the sensor unit is prevented, and control unit 10 and/or control unit 27 prevents activation of radar 11 and outputs corresponding information to driver 12 of the motor vehicle. Following step 33, the method again continues using step 32.

If it is determined in step 32 that alignment has occurred, i.e., the sensor unit is no longer in the delivery state, the method continues with a step 34. In step 34, the operation of radar system 11 is enabled.

A conventional alignment method, in connection with which the corresponding information that alignment has occurred is automatically introduced into the control unit, for example in step 32 of the method according to the present invention.

Method steps 31 to 34 primarily relate to when a new motor vehicle is delivered to a customer after production without an aligned radar sensor 11. Subsequent method steps 35 to 39 immediately follow method step 34 and predominantly cover the later driving operation of the motor vehicle.

In step 35, an automatic misalignment detection is performed in a conventional manner. The degree of misalignment resulting in step 35 is written in coded form in the memory of the control unit in step 36. In subsequent step 37, it is checked whether the degree of misalignment written in the memory exceeds an applicable threshold value. If this is not the case, step 38 follows step 37, in that further operation of radar system 11 is possible. Following step 38, the method again continues with step 35. In contrast, if it is determined in step 37 that the degree of misalignment exceeds the applicable threshold value, the radar system is deactivated in step 39. Furthermore, the corresponding information is introduced into the control unit and, if necessary, information is output to the driver of the motor vehicle. After step 39, the method again continues using step 31, which prevents startup of the radar system as long as realignment has not occurred.

In principle, the information about the degree of misalignment and the information which prevents startup may be stored in various storage locations in the control device, however, organization using only one storage location is also possible. In the latter case, which minimizes storage space, the introduction of the information in step 39 may be omitted, since the degree of misalignment introduced already prevents enabling operation after steps 32 and 34.

What is claimed is:

1. A method for operating at least one of a cruise control and an adaptive cruise control system of a motor vehicle having a sensor unit alignable in relation to a radiation characteristic and having a control unit, comprising the step of:
introducing information that prevents operation of the sensor unit for as long as the sensor unit is not aligned into the control unit before a first startup of the system.

2. The method according to claim 1, further comprising the steps of:
changing in a corresponding manner the information in the control unit; and
enabling operation of the system when the system is aligned.

3. The method according to claim 1, wherein the information is coded to differentiate between various states.

4. The method according to claim 3, wherein the various states include at least one of a delivery state, a sensor misaligned state, and alignment performed state.

5. The method according to claim 3, further comprising the steps of:
deactivating the system when an applicable threshold value is exceeded; and
preventing reactivation of the system for as long as the system is not realigned;
wherein the various states characterize a degree of misalignment of the radiation characteristic of the sensor unit.

6. The method according to claim 1, further comprising the step of introducing the information into the control unit during one of production of the control unit, replacement of the sensor unit, and programming at an end of a production line during production of the motor vehicle.

7. A system for at least one of cruise control and adaptive cruise control of a motor vehicle, comprising:
a sensor unit alignable in relation to a radiation characteristic; and
a control unit;
wherein information configured to prevent operation of the sensor unit for as long as the sensor unit is not aligned is introduced into the control unit before a first startup of the system.

8. The system according to claim 7, further comprising a storage location for the information into which data, which characterizes various states of a degree of misalignment of the radiation characteristic of the sensor unit, is introduced during operation of the system.

9. A control device for at least one of a cruise control and an adaptive cruise control system of a motor vehicle, the system including a sensor unit and a control unit, comprising:
an arrangement configured to introduce information into the control unit, the information configured to prevent operation of the sensor unit for as long as the sensor unit is not aligned.

10. The control device according to claim 9, wherein the control device includes the sensor unit and represents one structural unit.

11. A computer program stored on a memory configured to be executed by a computer, the computer program comprising program code for operating a control device of at least one of a cruise control and an adaptive cruise control system of a motor vehicle in accordance with a method for operating at least one of a cruise control and an adaptive cruise control system of a motor vehicle having a sensor unit alignable in relation to a radiation characteristic and having a control unit, the method including the step of:
introducing information that prevents operation of the sensor unit for as long as the sensor unit is not aligned into the control unit before a first startup of the system.

12. The computer program according to claim 11, wherein the memory includes a computer-readable data carrier.

13. A motor vehicle, comprising:
a system for at least one of cruise control and adaptive cruise control of a motor vehicle, the system including:
a sensor unit alignable in relation to a radiation characteristic; and
a control unit;
wherein information configured to prevent operation of the sensor unit for as long as the sensor unit is not aligned is introduced into the control unit before a first startup of the system.
